(19) United States
(12) Patent Application Publication
(10) Pub. No.: US 2009/0288255 A1
(43) Pub. Date: Nov. 26, 2009

(54) STRETCHER

(76) Inventors: Kazutoshi Sakurai, Nagano City (JP); Chieko Sakurai, Nagano (JP)

Correspondence Address: QUICKPATENTS, INC., 32861 CALLE PERFECTO, SUITE A, SAN JUAN CAPISTRANO, CA, 92675, US

(21) Appl. No.: 12/471,218

(22) Filed: May 22, 2009

(30) Foreign Application Priority Data
May 22, 2008 (JP) JP 2008-113773

(51) Int. Cl. A61G 1/00; A61G 1/04; A61G 1/06

(52) U.S. Cl. 5/625; 5/706

(57) ABSTRACT

This invention provides a stretcher that can be placed anywhere and on any surface without any concern, and that can be moved by sliding easily and smoothly on rough surfaces including indoor carpets, stairs and various types of roads. To structure the stretcher equipped with a mattress on which an injured/immobilized person can be placed and carrying means for the purpose of at least carrying a mattress, assemble a mattress on which an injured/immobilized person can be placed, a synthetic resin support panel placed below the mattress by having a designated thickness, flexibility and dimensions similar to the mattress and carrying means attached to the support panel.

### CROSS-REFERENCE TO RELATED APPLICATIONS

This application is related to our Japanese patent application #JP 2008-113773, published on May 22, 2008, priority not being claimed thereto.

### STATEMENT REGARDING FEDERALLY SPONSORED RESEARCH AND DEVELOPMENT

Not Applicable.

### FIELD OF THE INVENTION

This invention relates to stretchers, and more particularly to a flexible stretcher equipped with a mattress on which an injured/immobilized person can be placed and carried.

### DISCUSSION OF RELATED ART

The prior art has many known stretchers that can carry and transport an injured/immobilized person or patient. The applicant of this invention has already proposed a stretcher that is ideal for this type of usage by submitting Japanese Utility Model Registration No. 2057444 (Gazette of JITSUKOU HEI 6-21466).

The stretcher related to the Japanese Utility Model Registration No. 2057444 has a bendable mattress to place the person on and has holding sections located along both of the long-edges of the mattress to thread belts through. Flexible belts are provided that can be threaded thought the holding sections at opposing edges to form a loop for securing the patient or to be used as handles for carrying. The mattress becomes a large cushion when air flows into it, and it can be folded into a compact shape by rolling it up and removing the air. However, the aforementioned stretchers have the following problems to be solved.

Firstly, since the mattress is used in a physical state in which air is maintained inside the mattress, there is a possibility that the mattress could be punctured as soon as the injured/immobilized person is placed on a stretcher that is laid on the ground if there are sharp-edged stones or broken branches beneath the mattress. In this case, even if the mattress does not become totally useless, the intended performance of the stretcher with the mattress may not be maintained. Therefore, a stretcher is needed that can be used even if punctured.

Secondly, there may be a need for sliding and dragging the stretcher on floors inside a building or over stairs because this would be the easier and smoother way of moving the stretcher, especially when the stretcher has to be moved by one person. The conventional stretchers may be dragged on a flat floor, but usually it is difficult to drag them on carpet, a road surface, or up/down stairways. Therefore, there are limits on the convenience and usability of the conventional stretcher. Therefore, a stretcher is needed that can be easily slid or dragged by one person on a variety of surfaces.

Thirdly, in a conventional stretcher, the carrying belts are usually attached directly to the mattress or the mattress cover. The stress (tensile force) of the belts are directly applied to the mattress or the cover, and the mattress or the cover may be damaged easily especially over the prolonged use. Therefore, a stretcher is needed that has carrying means for the mattress in such a way to minimize the damage caused from prolonged use.

Fourthly, there are cases in which it is desired to rigidly stabilize the posture of the whole body or part of the body of the injured/immobilized person to be transported, but the conventional stretcher cannot deal with this type of usage. Therefore, for this case, additional means to stabilize the body posture rigidly must be provided in parallel for the conventional stretcher. Thus, the conventional stretcher is insufficient from the viewpoint of multi-usage and multi-functionality. Therefore, a stretcher is needed that provides additional stabilization of the body posture.

Therefore, a stretcher is needed that can be used even if punctured. Also, a stretcher is needed that can be easily slid or dragged by one person on a variety of surfaces. Also, a stretcher is needed that has carrying means for the mattress in such a way to minimize the damage caused from prolonged use. And, a stretcher is needed that provides additional stabilization of the body posture. The present invention accomplishes these objectives.

### SUMMARY OF THE INVENTION

The present device is a stretcher equipped with a mattress on which an injured or immobilized person can be placed and carried. The stretcher includes a mattress, a carrying means and a support panel. The overall size of the mattress is configured to be a rectangle so that the injured/immobilized person can be laid down on it for transporting.

At least two types of mattress can be chosen from as the ideal embodiment for use as the mattress. The embodiment of the stretcher can select any one of these mattresses and be functional. A preferred embodiment of the mattress utilizes a shape-memorizing, vacuum-formed mattress that retains in memory the mattress shape that existed just prior to vacuuming the internal air out. A second embodiment of the mattress can be a cushion-type mattress that becomes like a large cushion when air flows into it. Also, the mattress can be attached to the support panel by mating a set of multiple attachment sections provided along the periphery of the mattress to another set of multiple attachment sections (the other mating side) provided at corresponding positions on the support panel.

A synthetic resin support panel placed below the mattress by having a designated thickness, flexibility and dimensions similar to the mattress and carrying means attached to the support panel. Also, TPO synthetic resin can be used for the support panel. At least the upper surface of the support panel can be treated for slip resistance. More specifically, the support panel can be composed of two layers of synthetic resin sheets in which the first synthetic resin sheet used for the upper panel section is treated for slip resistance to retain the mattress and the second synthetic resin sheet used for the lower panel section has a slippery surface to ease the sliding or dragging of the device over a variety of surfaces. Furthermore, carrying parts can be attached to the support panel through holes provided on the support panel, instead of the mattress, or using multiple coupling parts connected to ropes threaded through the holes in the support panel.

The present invention is a stretcher that can be used even if punctured. The stretcher can be easily slid or dragged by one person on a variety of surfaces. Also, the stretcher has carrying means for the mattress in such a way to minimize the damage caused from prolonged use. Further, the present device is a stretcher that provides additional stabilization of the body posture. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating the stretcher in use;

FIG. 2 is an exploded view of the mattress and the support panel;

FIG. 3 is a cross section diagram showing a part of this stretcher, taken generally along lines 3-3 of FIG. 2;

FIG. 4 is a cross section diagram showing the area near the air suction valve, taken generally along lines 4-4 of FIG. 2;

FIG. 5 is a perspective view of the carrying means of the invention;

FIG. 6 is a front elevational view, illustrating the stretcher in a folded state;

FIG. 7 is a perspective view of the invention, illustrating a transporting state of the stretcher;

FIG. 8 is a perspective view of the invention, illustrating another transporting state of the stretcher; and

FIG. 9 is a perspective view of the invention, illustrating another transporting state of the stretcher.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

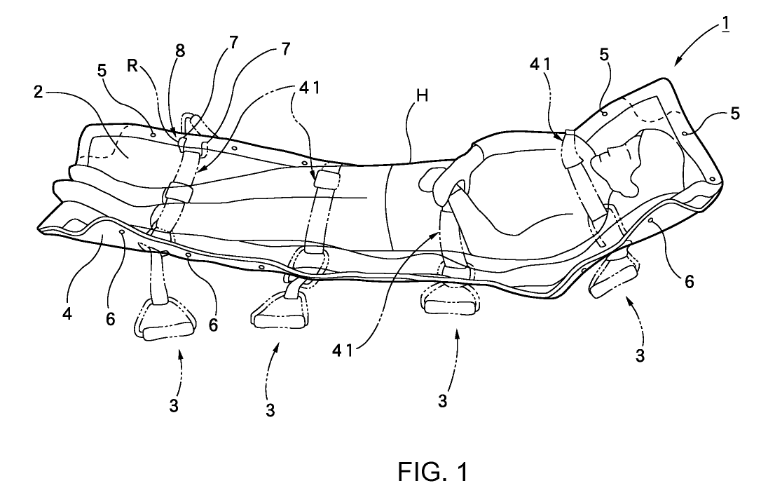

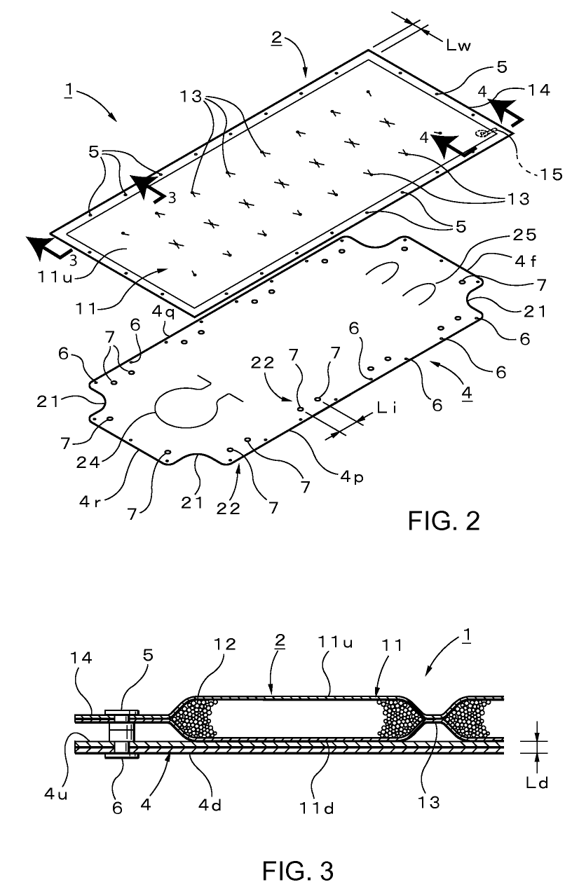

With respect to the drawings, FIG. 1 illustrates a stretcher 1. The major components provided for the stretcher 1 are one piece of a mattress 2, one or more pieces of a carrying means 3 and one piece of a support panel 4. The overall size of the mattress 2 is configured to be a rectangle as shown in FIG. 2 so that the injured/immobilized person H can be laid down on it for transporting. At least two types of mattress can be chosen from as the ideal embodiment for use as the mattress 2. The embodiment of the stretcher 1 can select any one of these mattresses and be functional.

A first embodiment of the mattress 2 utilizes a shape-memorizing, vacuum-formed mattress that retains in memory the mattress shape that existed just prior to vacuuming the internal air out. The first embodiment of the mattress 2 is shown in FIG. 3. This mattress 2 is configured by overlaying an upper and lower (total of two) synthetic resin sheets 11u and 11d that have excellent characteristics regarding non-flammability, waterproofing and strength. As shown in FIG. 2, four edges around the entire periphery of the sheets are sealed for a designated width Lw, forming a bag-shaped pack section 11. Fillers 12, in particle form, are injected and stored inside the pack section 11. Preferably, a resin foam powder (preferably made by Vinyl Technology, Inc. USA, but can other suitable materials can be used, as desired) with a particle size of less than 1 [mm] can be used as the fillers 12. When the resin foam powder is injected inside the pack section 11 and the internal air of the pack section 11 is vacuumed out, then the resin foam powder has the characteristic of retaining the shape that existed just prior to vacuuming the air out. Therefore, when this shape-memorizing, vacuum-formed mattress is utilized and when it is necessary to rigidly stabilize the posture of the whole body of the injured/immobilized person to be transported, the stretcher 1 of this invention can rigidly stabilize the body posture of the injured/immobilized person H without requiring additional means to accomplish this. Thus, the stretcher 1 of this invention is superior in its multi-usage and multi-functionality.

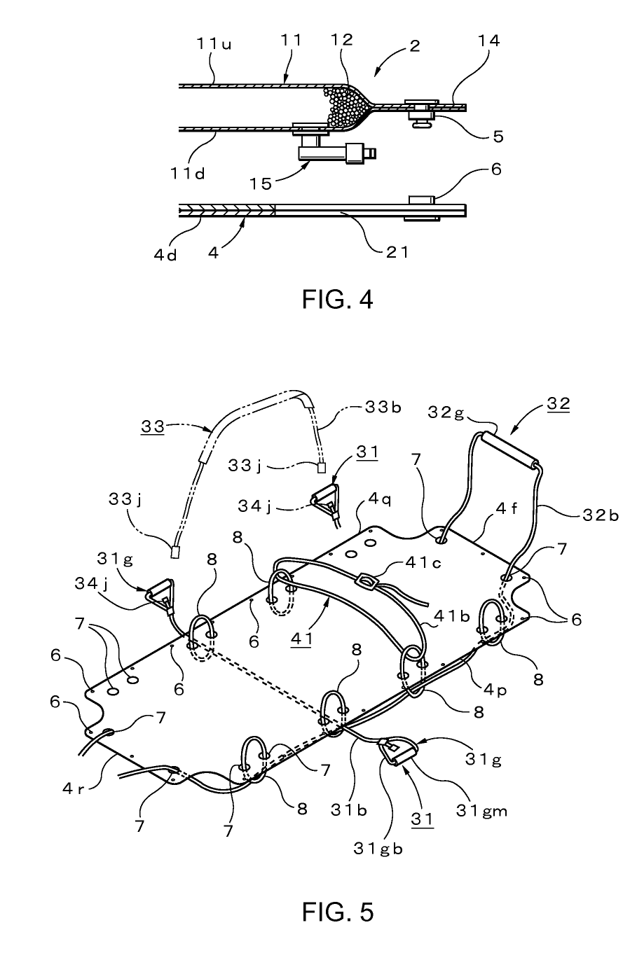

In addition, in order to prevent the fillers 12 stored in the pack section 11 from unevenly dislocating to one side, adhesion sections 13 are provided at a certain distance apart so that the sheets 11u and 11d are stuck together at several points as shown in FIGS. 2 and 3. A pack flange section 14, having the designated width Lw, is formed along the four edges around the entire periphery. Utilizing this pack flange section 14, multiple attachment sections 5, representing one side of the mating pair of buttons, are installed along the flange, meaning that multiple buttons 5 of one mating side are installed along the periphery of the pack section 11 (the mattress 2) at certain distances apart. As shown in FIGS. 2 and 4, near one corner, an air suction valve (a check valve) 15 is installed on an outer surface of the lower sheet 11d to vacuum the air out from the pack section 11. A separately provided vacuum pump (not shown) is connected to the air suction valve 15 to vacuum out the air from the pack section 11. Typically within several seconds the target amount of the air can be vacuumed out.

A second embodiment of the mattress 2 can be a cushion-type mattress that becomes like a large cushion when air flows into it. In a preferred embodiment, the mattress described in the JITSUKOU HEI 6-21466 can be utilized. In this case, for the second embodiment of the mattress 2, it is desirable to use an automatic suction type mattress that automatically sucks the air in simply by opening a valve cap. Therefore, the use of the known JITSUKOU HEI 6-21466 mattress for a cushion-type mattress has the advantage of further enhancing the added value of the stretcher 1.

The support panel 4 is configured as a single unit that is flexible overall, and is made of a flexible synthetic resin having a designated thickness Ld of 2 [mm]. The support panel 4, shown as examples in FIG. 3 and FIG. 4, is preferably constructed from a multi-layer TPO (thermo polyolefin) synthetic resin manufactured by Tsutsunaka Plastic Industry Co., Ltd, though other suitable materials can be used. The support panel 4 is a two-layer construction in which an upper panel section 4u uses the first synthetic resin sheet treated for slip resistant and a lower panel section 4d uses the second synthetic resin sheet having a slippery surface. Having the TPO synthetic resin used for the support panel 4, a good performance can be realized for dragging the stretcher 1 when transporting. Also, the two-layer construction allows the ability to maintain the mattress 2 stably on the surface of the support panel 4 without slippage and dislocation, and enables one person to drag and slide the stretcher 1 easily and smoothly for transporting.

As shown in FIG. 2, the support panel 4 is configured to be about the same size as the mattress 2, and the four corners of the support panel 4 are inwardly cut out to form the cutout sections 21 in order to keep the air suction valve 15 from hitting the support panel 4. Also, multiple attachment buttons 6 (the other side of the mating pair) are installed along the entire periphery (four edges) of the support panel 4. These buttons 6 of the panel side are located at corresponding positions with respect to the attachment buttons 5 of the mattress 2 assuming the support panel 4 is laid underneath the mattress 2. The multiple holes 7 are installed along two long edges 4p and 4q (among the total four edges) of the support panel 4. Two holes 7 and 7 that are closely spaced by the set distance Li are paired together to form the rope attachment section 22. Four of these rope attachment sections 22 are provided at a certain distance apart on each of the long edges 4p and 4q. For each short edge 4f and 4r, two holes 7 are provided and spaced considerably apart. In a preferred embodiment, the entire support panel 4 can be transparent or semitransparent (translucent white), and have the position identifications 24 and 25 indicated on the support panel 4 for placing the patient H.

The carrying means 3 are installed utilizing the support panel 4. The carrying means 3 are means to transport the stretcher 1, therefore various forms and types can be utilized as the carrying means 3, with several embodiments detailed below. For attaching the carrying means 3, the holes 7 provided on the support panel 4 are utilized. The holes 7 provided on the short edges 4f and 4r of the support panel 4 are used for directly inserting loop belts 32 that are described later. On the other hand, the holes 7 provided on the long edges 4p and 4q of the support panel 4 are used for attaching coupling parts 8. Accordingly, the rope R is threaded through the pair of holes 7 and 7, which is a rope attachment section 22, and both ends of the rope are tied together to form a loop producing the coupling section 8 (refer to FIG. 5). Thus the four coupling section 8 can be produced on each long edge 4p (or 4q) and the total of eight coupling sections 8 for both long edges 4p and 4q. The carrying means 3 can be attached to the support panel 4 utilizing the coupling sections 8.

As described above, when the carrying means 3 are attached to the support panel 4 through the holes 7 provided on the support panel 4 or using the coupling parts 8 that are formed by threading the ropes R through the holes 7 on the support panel 4, the stress (the tensile force) of the carrying means 3 will not be applied to the mattress 2, and the mattress will not be damaged easily, even under prolonged use. Thus there is the advantage of increasing the durability of the stretcher 1.

In FIG. 5, various examples of the carrying means 3 are identified. Even though the various carrying means 3 are shown as ropes in FIG. 5 just for convenience sake, the carrying means 3 can be configured into any shape or form depending on the usage purpose such as the belt having a certain width as shown in FIG. 1.

One carrying means 3 is a hand belt 31. The hand belt 31 consists of the belt section 31b that is inserted through the left and right coupling sections 8 and 8 on the underside of the support panel 4, and hand grips 31g and 31g that are attached to both ends of belt section 31b. The hand grip 31g is constructed by threading grip belt 31gb through pipe shaped grip main body 31gm and by tying both ends of the grip belt 31gb to the end of the belt section 31b. Even though only one hand belt 31 is shown in FIG. 5, a total of four hand belts 31 can be prepared and attached to the coupling sections 8 at four front and back locations.

Another carrying means 3 is a loop belt 32. The loop belt 32 is configured using belt section 32b that is threaded as follows. One end of the belt section 32b is first inserted from the top side into one of the holes 7 located at the short edge 4r of the support panel 4, then is threaded through the coupling sections 8 exposed at the bottom of the support panel 4, sequentially along one edge, and then is inserted from the bottom side into the nearer hole 7 located at the other short edge 4f. Then the end of the belt section 32b is inserted from the top side into the other hole 7 located on the short edge 4f, then is threaded through the coupling sections 8 exposed at the bottom of the support panel 4, sequentially along another edge, and then inserted from the bottom side into the other hole 7 located at the short edge 4r. Then the end is tied to the other end of the belt section 32b. Also, grip section 32g is installed to the belt section 32b that is exposed above the support panel 4 at each of the 4r and 4f sides. The grip section 32g is shaped as a pipe, and the belt section 32b is inserted through it.

Another carrying means 3 is a shoulder belt 33. The shoulder belt 33 consists of belt section 33b and joint sections of one mating side 33j and 33j that are tied to each end of the belt section 33b. In this case, the joint sections of other mating side 35j and 35j are attached each end of the belt section 31b of the hand belt 31. Then the joint section of one mating side 33j can be tied to (or removed from) the joint section of the other mating side 35j. FIG. 5 shows only one shoulder belt 33 using the virtual line, however, two shoulder belts 33, one at left and the other at right, can be attached for use.

An additional component of the carrying means 3 is a safety belt 41. The safety belt 41 consists of belt section 41b that is threaded through two coupling parts 8 and 8 that are exposed upward at the left and right sides of the support panel 4, and buckle 41c that ties (or removes) the two ends of the belt section 41b. FIG. 5 shows only one safety belt 41, however, a total of up to four safety belts 41 can be prepared and attached to the coupling parts 8 at four front and back positions. In one position, the buckle 41c of the safety belt 41 could hit a head of the patient H, therefore a buckle 41c that would not affect the patient H even if it hit the head could be used, or another type of fastening means such as a mask fastener, instead of a buckle, could be used.

Next, the functions and usage methods of the stretcher 1 related to this embodiment are described referencing FIGS. 1 through 9. In these descriptions, it shall be assumed that the first embodiment (the shape-memorizing, vacuum-formed mattress) will be used for the mattress 2.

When the stretcher 1 is not in use, the mattress 2 and the support panel 4 shall be separated and rolled up, and then stored in a bag (not shown in Figures). They can be carried around freely in the bag. In this case, the rolled up mattress 2 can be stored inside the rolled up support panel 4. Each of the coupling parts 8 can be attached to the support panel 4 in advance. Also, the carrying means 3 and the safety belts 41 can be attached to the support panel 4 in advance as needed.

When using the stretcher 1, the support panel 4 is unrolled first after being taken out of the bag. In this case, the support panel 4 will unroll and expand by itself with its own elasticity. If the support panel 4 is placed on a flat surface, it will roll out and expand flat along the flat surface as shown in FIG. 2. Next, the mattress 2 is unrolled and placed on the support panel 4. Then, the buttons 5 of one mating side will be tied to the buttons 6 of the other mating side to attach the mattress 2 to the support panel 4 as shown in FIG. 3. Since the mattress 2 and the support panel 4 can be attached and detached freely and easily as described, the mattress 2 can be interchanged with another type easily while using the common support panel 4. Thus, the stretcher 1 of this embodiment further enhances multi-use characteristics and convenience.

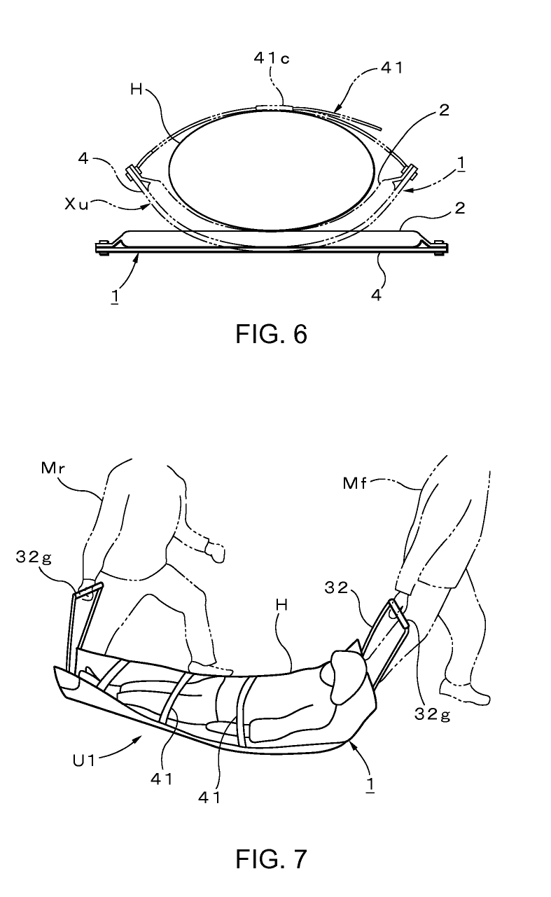

Since the basic assembly of the stretcher 1 is completed by the step above, now the injured/immobilized person/patient H is placed and laid down on the mattress 2, and the safety belts 41 are fastened to secure the injured/immobilized person/patient H. In this instant, the safety belts 41 can be tightened as much as needed to make the stretcher 1 be in the most ideal shape for the injured/immobilized person/patient H, such as bending the stretcher 1 curling up along the injured/immobilized person/patient H as shown by the broken line in position Xu of FIG. 6, or bending the stretcher 1 at the middle in the dog-legged shape as shown in FIG. 1. While in this state, the separately provided air pump is attached to the air suction valve 15 of the mattress 2, and the internal air of the mattress 2 is vacuumed out. The target amount of the air can be vacuumed out within several seconds. As soon as the air is vacuumed out, the mattress 2 retains the shape that existed just prior to vacuuming the internal air out. This state is illustrated in FIG. 1.

Furthermore, the desired types of carrying means 3 are selected as is appropriate for the transporting situations, and are installed on the support panel 4.

FIG. 7 shows a transporting state U1 using the loop belt 32. In the transporting state U1, two carriers Mf and Mr, situated at the forward and rear of the stretcher 1, are carrying the stretcher 1. The forward carrier Mf is grabbing the grip section 32g attached to the loop belt 32 that is extending out from the front edge of the support panel 4. Similarly, the rear carrier Mr is grabbing the grip section 32g attached to the loop belt 32 that is extending out from the rear edge of the support panel 4. The example shown indicates a transporting state in which the stretcher 1 is dragged on a surface such as carpets. Particularly in the transporting state U1, the stretcher 1 can be dragged up and down stairs or on the ground (a rough road surface), and can be transported by one carrier Mf.

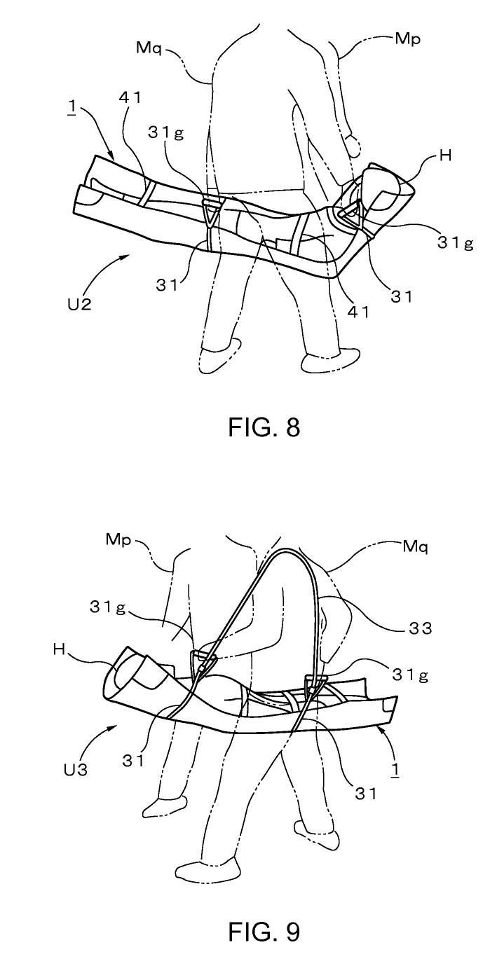

FIG. 8 shows a transporting state U2 using the hand belts 31. In the transporting state U2, two carriers Mp and Mq, situated at the right and left of the stretcher 1, are carrying the stretcher 1. The right-side carrier Mp is lifting the stretcher 1 with both hands by grabbing the hand grips 31g and 31g located at right side of the stretcher 1. Similarly the left-side carrier Mq is lifting the stretcher 1 with both hands by grabbing the hand grips 31g and 31g located at left side of the stretcher 1.

FIG. 9 shows a transporting state U3 using the shoulder belts 33. In the transporting state U3, two carriers Mp and Mq, situated at the right and left of the stretcher 1, are carrying the stretcher 1 by using additional shoulder belts 33. The right-side carrier Mp is lifting the stretcher 1 with both hands by grabbing the handgrips 31g and 31g located at right side of the stretcher 1 and, in addition, by hanging over the shoulder the shoulder belt 33 that is tied to the hand belts 31. Similarly the left-side carrier Mq is lifting the stretcher 1 with both hands by grabbing the handgrips 31g and 31g located at left side of the stretcher 1 and, in addition, by hanging over the shoulder the shoulder belt 33 that is tied to the hand belts 31.

As described above, since the stretcher 1 related to this embodiment consists of the mattress 2 on which the injured/immobilized person H can be placed, the flexible synthetic resin support panel 4 having the designated thickness Ld and being shaped to approximately the same size as the mattress 2, and attached to and laid underneath the mattress 2, and the carrying means 3 installed on the support panel 4, there is no fear of having the mattress 2 punctured when the stretcher 1 is laid on the ground even if there are sharp-edged stones or broken branches underneath the stretcher. Thus the mattress 2 can be assuredly protected. Therefore, the stretcher 1 of this embodiment can be placed anywhere or on any surface without any concern. Since the stretcher 1 can be moved by dragging or sliding easily and smoothly on rough surfaces including indoor carpets, stairs and roads, a reduction in time and labor can be realized in transporting the stretcher 1 of this embodiment. The convenience and usability of the stretcher of this invention are enhanced; particularly, the stretcher 1 of this embodiment enables one person to move the stretcher easily. Therefore the stretcher 1 related to this embodiment is ideal to carry on emergency vehicles and to use in rescue operations such as traffic accidents, and to use in narrow locations such as condos and apartments.

The ideal embodiments of this invention have been described above, but the embodiments of this invention are not limited to what has been described above. Within the scope of this invention, an embodiment can be varied, added to, or deleted freely in such factors and parameters as the detailed configuration, the shape, the materials, quantity, numerical values, etc.

For example, the shape-memorizing, vacuum-formed mattress and the cushion-type mattress have been described for the mattress 2, but this does not eliminate or exclude other types of mattresses. Also, for the configuration of attaching and detaching the mattress 2 and the support panel 4, the button sections 5 of one mating side and the button sections 6 of the other mating side are shown, but this does not eliminate or exclude other predetermined unified configurations. For the support panel 4, the two-layer configuration has been described, but this can be a single layer configuration made of a slippery synthetic resin as long as one surface has been treated for slip resistance, such as a coating or surface treatment.

While a particular form of the invention has been illustrated and described, it will be apparent that various modifications can be made without departing from the spirit and scope of the invention. Accordingly, it is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A stretcher on which a person can be placed and carried, the stretcher comprising:
a mattress on which the person can be placed;
a support panel placed below the mattress with a designated thickness, flexibility and dimensions similar to the mattress;
a carrying means attached to the support panel;
whereby an injured/immobilized person can be placed on the combined mattress and support panel and carried via the carrying means.

2. The stretcher of claim 1 wherein the support panel is made of synthetic resin.

3. The stretcher of claim 1 wherein the mattress is a shape-memorizing, vacuum-formed mattress that retains in memory the mattress shape that existed just prior to vacuuming the internal air out.

4. The stretcher of claim 1 wherein the mattress which is a cushion-type mattress that expands when air flows into it.

5. The stretcher of claim 1 wherein the mattress is attached to the support panel by mating a set of multiple attachment sections provided along the periphery of the mattress to another set of multiple attachment sections provided at corresponding positions on the support panel.

6. The stretcher of claim 1 wherein the support panel is made of TPO synthetic resin.

7. The stretcher of claim 1 wherein at least an upper side of the support panel is treated for slip resistance.

8. The stretcher of claim 6 wherein the support panel is composed of two layers of synthetic resin sheets in which a first synthetic resin sheet used for the upper panel section is treated for slip resistance and a second synthetic resin sheet used for the lower panel section has a slippery surface.

9. The stretcher of claim 1 wherein the carrying means are attached to the support panel through holes in the support panel.

10. The stretcher of claim 9 wherein the carrying means are attached to the support panel using multiple coupling parts connected to ropes threaded through the holes.
